(19) United States
(12) Patent Application Publication
(10) Pub. No.: US 2024/0249308 A1
(43) Pub. Date: Jul. 25, 2024

(54) INFORMATION PROCESSING DEVICE, AND INFORMATION PROCESSING METHOD

(71) Applicant: Toyota Jidosha Kabushiki Kaisha, Toyota-shi (JP)

(72) Inventors: Shuji Miyai, Toyota-shi (JP); Yasuyuki Kamezaki, Toyota-shi (JP); Masato Endo, Nagoya-shi (JP); Seira Nakata, Tokyo (JP)

(73) Assignee: Toyota Jidosha Kabushiki Kaisha, Toyota-shi (JP)

(21) Appl. No.: 18/419,646

(22) Filed: Jan. 23, 2024

(30) Foreign Application Priority Data
Jan. 25, 2023 (JP) 2023-009428

(51) Int. Cl. G06Q 30/0217; B60Q 9/00; G07C 5/02

(52) U.S. Cl. CPC G06Q 30/0217; B60Q 9/00; G07C 5/02

(57) ABSTRACT

An information processing device includes a control unit. The control unit is configured to: acquire information on driving of a user; determine, for each trip, whether a predetermined event has occurred based on the information on the driving of the user, and create a diagnostic report associated with the predetermined event; and notify the user that the diagnostic report is present in response to creation of the diagnostic report associated with the predetermined event.

### CROSS-REFERENCE TO RELATED APPLICATION

This application claims priority to Japanese Patent Application No. 2023-009428 filed on Jan. 25, 2023, incorporated herein by reference in its entirety.

### BACKGROUND

### 1. Technical Field

The present disclosure relates to an information processing device and an information processing method.

### 2. Description of Related Art

It is known to detect a physical quantity that changes based on at least one of traveling, steering, and braking of a vehicle or a physical quantity that changes by an operation on a predetermined operating member, and to calculate a driving operation score based on the detection value (for example, Japanese Unexamined Patent Application Publication No. 2022-138727 (JP 2022-138727 A)).

### SUMMARY

The present disclosure facilitates user access to a diagnostic report.

An information processing device according to a first aspect of the present disclosure includes a control unit. The control unit is configured to acquire information on driving of a user, determine, for each trip, whether a predetermined event has occurred based on the information on the driving of the user, and create a diagnostic report associated with the predetermined event, and notify the user that the diagnostic report is present in response to creation of the diagnostic report associated with the predetermined event.

In the information processing device according to the above aspect, the control unit may be configured to create the diagnostic report for the each trip based on the information on the driving of the user, notify the user that the diagnostic report is present for a trip in which the predetermined event has occurred, and not notify the user that the diagnostic report is present for a trip in which the predetermined event has not occurred.

In the information processing device according to the above aspect, the control unit may be configured to create the diagnostic report for a trip in which the predetermined event has occurred, and not create the diagnostic report for a trip in which the predetermined event has not occurred.

In the information processing device according to the above aspect, the control unit may be configured to create the diagnostic report for the each trip based on the information on the driving of the user, and notify the user that the diagnostic report associated with the predetermined event is present by changing, on a user interface for displaying a list of the diagnostic reports, a display format between a diagnostic report associated with a trip in which the predetermined event has occurred and a diagnostic report associated with a trip in which the predetermined event has not occurred.

In the information processing device according to the above aspect, the control unit may be configured to notify the user that the diagnostic report associated with the predetermined event is present by displaying information indicating that the diagnostic report associated with the predetermined event is present on an initial screen of a user interface for providing the diagnostic report in response to occurrence of the predetermined event.

The information processing device according to the above aspect may further include a storage unit configured to store information on a plurality of messages associated with the predetermined event. The control unit may be configured to contain, in the diagnostic report, a message that satisfies a predetermined condition among the messages in response to occurrence of the predetermined event.

The information processing device according to the above aspect may further include a storage unit configured to store information on a plurality of messages associated with the predetermined event. The control unit may be configured to display a message that satisfies a predetermined condition among the messages on an initial screen of a user interface for providing the diagnostic report in response to occurrence of the predetermined event.

In the information processing device according to the above aspect, the control unit may be configured to select a message different from a previous message or a message on a previous day as the message that satisfies the predetermined condition.

In the information processing device according to the above aspect, the control unit may be configured to acquire information on a tendency of messages referred to by the user, and select a message with the same tendency as the tendency of the messages referred to by the user as the message that satisfies the predetermined condition.

In the information processing device according to the above aspect, the control unit may be configured to generate information on an incentive based on the information on the driving of the user, and provide a cap for the incentive in every trip or every predetermined period.

In the information processing device according to the above aspect, the control unit may be configured to contain the information on the incentive in the diagnostic report.

An information processing method executed by a computer according to a second aspect of the present disclosure includes acquiring information on driving of a user, determining, for each trip, whether a predetermined event has occurred based on the information on the driving of the user, and creating a diagnostic report associated with the predetermined event, and notifying the user that the diagnostic report is present in response to creation of the diagnostic report associated with the predetermined event.

The information processing method according to the above aspect may further include creating the diagnostic report for the each trip based on the information on the driving of the user, notifying the user that the diagnostic report is present for a trip in which the predetermined event has occurred, and not notifying the user that the diagnostic report is present for a trip in which the predetermined event has not occurred.

The information processing method according to the above aspect may further include creating the diagnostic report for a trip in which the predetermined event has occurred, and not creating the diagnostic report for a trip in which the predetermined event has not occurred.

The information processing method according to the above aspect may further include creating the diagnostic report for the each trip based on the information on the driving of the user, and notifying the user that the diagnostic report associated with the predetermined event is present by changing, on a user interface for displaying a list of the diagnostic reports, a display format between a diagnostic report associated with a trip in which the predetermined event has occurred and a diagnostic report associated with a trip in which the predetermined event has not occurred.

The information processing method according to the above aspect may further include notifying the user that the diagnostic report associated with the predetermined event is present by displaying information indicating that the diagnostic report associated with the predetermined event is present on an initial screen of a user interface for providing the diagnostic report in response to occurrence of the predetermined event.

The information processing method according to the above aspect may further include containing, in the diagnostic report, a message that satisfies a predetermined condition among a plurality of messages associated with the predetermined event in response to occurrence of the predetermined event.

The information processing method according to the above aspect may further include displaying a message that satisfies a predetermined condition among a plurality of messages associated with the predetermined event on an initial screen of a user interface for providing the diagnostic report in response to occurrence of the predetermined event.

The information processing method according to the above aspect may further include selecting a message different from a previous message or a message on a previous day as the message that satisfies the predetermined condition.

The information processing method according to the above aspect may further include generating information on an incentive based on the information on the driving of the user, and providing a cap for the incentive in every trip or every predetermined period.

A third aspect of the present disclosure relates to a program for causing a computer to perform the information processing method described above, or a non-transitory recording medium storing the program.

According to the present disclosure, it is possible to facilitate the user access to the diagnostic report.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to a first embodiment;

FIG. 2 is a block diagram schematically showing an example of configurations of a vehicle, a user terminal, and a server constituting the system according to the first embodiment;

FIG. 3 is a diagram showing an example of a functional configuration of the server according to the first embodiment;

FIG. 4 is a diagram showing an example of a table configuration of a vehicle information database (DB) according to the first embodiment;

FIG. 5 is a diagram showing an example of a table configuration of a detection information DB according to the first embodiment;

FIG. 6 is a diagram showing an example of an image displayed on the user terminal when the user terminal is notified that a diagnostic report is created;

FIG. 7 is a diagram showing an example of an initial screen when an application is activated in response to detection of a predetermined behavior;

FIG. 8 is a diagram showing a relationship between scores and threshold values associated with predetermined behaviors;

FIG. 9 is a diagram showing data on messages associated with items stored in message data;

FIG. 10 is a diagram showing an example of a screen when a list of diagnostic reports is displayed;

FIG. 11 is a diagram showing an example of a screen when a diagnostic report is opened;

FIG. 12 is a diagram showing an example of a screen displayed when a deceleration item is tapped;

FIG. 13 is a diagram showing an example of a functional component of an electronic control unit (ECU) according to the first embodiment;

FIG. 14 is a diagram showing a functional configuration of the user terminal according to the first embodiment;

FIG. 15 is a flowchart of a diagnostic report notification process in the server according to the first embodiment;

FIG. 16 is a flowchart of a process for generating advice to be displayed on the initial screen;

FIG. 17 is a flowchart of a diagnostic report notification process in the server according to a second embodiment;

FIG. 18 is a diagram showing an example of an initial screen when an incentive has reached an upper limit;

FIG. 19 is a diagram showing an example of a diagnostic report when an incentive is given;

FIG. 20 is a flowchart of a process for giving an incentive in the server according to a fourth embodiment; and

FIG. 21 is a flowchart of another process for generating advice to be displayed on the initial screen.

### DETAILED DESCRIPTION OF EMBODIMENTS

Many related-art driving diagnosis systems issue a diagnostic report for each trip. If there is no characteristic driving behavior, however, similar diagnostic reports are issued. Therefore, there is no interest for a user. If such diagnostic reports are issued continuously, the user is bored and eventually stops viewing the diagnostic reports.

In view of the above, an information processing device according to one aspect of the present disclosure includes a control unit configured to acquire information on driving of a user, determine, for each trip, whether a predetermined event has occurred based on the information on the driving of the user, and create a diagnostic report associated with the predetermined event, and notify the user that the diagnostic report is present in response to creation of the diagnostic report associated with the predetermined event.

The predetermined event is an event that is desirably reported to the user. For example, when a predetermined behavior that calls the user's attention has occurred, determination is made that the predetermined event has occurred. The predetermined behavior that calls the user's attention is, for example, a behavior that may cause annoyance to surrounding vehicles or may induce an accident. Examples of the predetermined behavior include sudden steering, sudden deceleration (also referred to as “sudden braking”), sudden acceleration, overspeed, and short-time activation of a turn signal (also referred to as “short-time turn signal”). Examples of the predetermined event also include good events such as better fuel efficiency than usual and safe traveling of 500 km.

The information on the driving of the user is, for example, sensor output values transmitted from a vehicle. The trip is a unit of traveling from the time when a system power supply of the vehicle is turned ON to the time when the system power supply of the vehicle is turned OFF. In a vehicle including an engine, the trip may be a unit of traveling from the start of the engine to the stop of the engine. The diagnostic report presents a result of user's driving diagnosis to the user. The diagnostic report may include, for example, a message associated with the predetermined event.

The diagnostic report may be created for each trip. In this case, the user is notified when the diagnostic report is created for a trip in which the predetermined event has occurred instead of being notified every time the diagnostic report is created. Therefore, when the predetermined event has not occurred, the user is not notified even if the diagnostic report is created. However, the user may refer to the diagnostic report that the user is not notified about.

The diagnostic report may be created only for a trip in which the predetermined event has occurred. In this case, the user is notified every time the diagnostic report is created. In any case, the user is notified when the diagnostic report is created for the trip in which the predetermined event has occurred. Therefore, when the user receives the notification, at least the diagnostic report associated with the predetermined event has been created. Thus, the user can obtain useful information. Since the user is not notified when the predetermined event has not occurred, it is possible to reduce the occurrence of a case where the user is bored. The notification to the user may be push notification by application software (hereinafter also referred to as “application”) installed in a user's terminal, e-mail, or the like.

Hereinafter, embodiments of the present disclosure will be described with reference to the drawings. The configurations of the following embodiments are illustrative, and the present disclosure is not limited to the configurations of the embodiments. The following embodiments can be combined if possible.

### First Embodiment

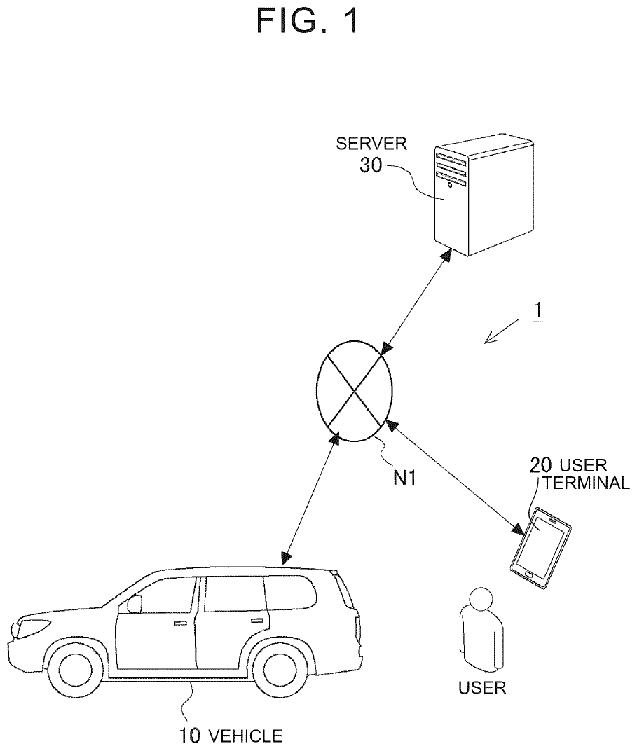

FIG. 1 is a diagram showing a schematic configuration of a system 1 according to a first embodiment. In the system 1, a server 30 performs driving diagnosis based on information on traveling of a vehicle 10, and notifies a user terminal 20 that a diagnostic report is issued when a predetermined behavior has occurred. The predetermined behavior is an example of a predetermined event.

In the example in FIG. 1, the system 1 includes the vehicle 10, the user terminal 20, and the server 30. The user terminal 20 is a mobile terminal owned by a user. The user terminal 20 is linked to the vehicle 10 and registered in the server 30. With the user terminal 20, it is possible to refer to a diagnostic report created for the vehicle 10.

The vehicle 10, the user terminal 20, and the server 30 are connected to each other by a network N1. The network N1 is a worldwide public communication network such as the Internet, and a wide area network (WAN) or other communication networks may be adopted. The network N1 may include a telephone communication network such as a mobile phone network, or a wireless communication network such as Wi-Fi (registered trademark). The vehicle 10 may be connected to the user terminal 20 via short-range wireless communication. Although FIG. 1 shows one vehicle 10 as an example, there may be a plurality of vehicles 10. Further, there may be a plurality of users and user terminals 20 depending on the number of vehicles 10.

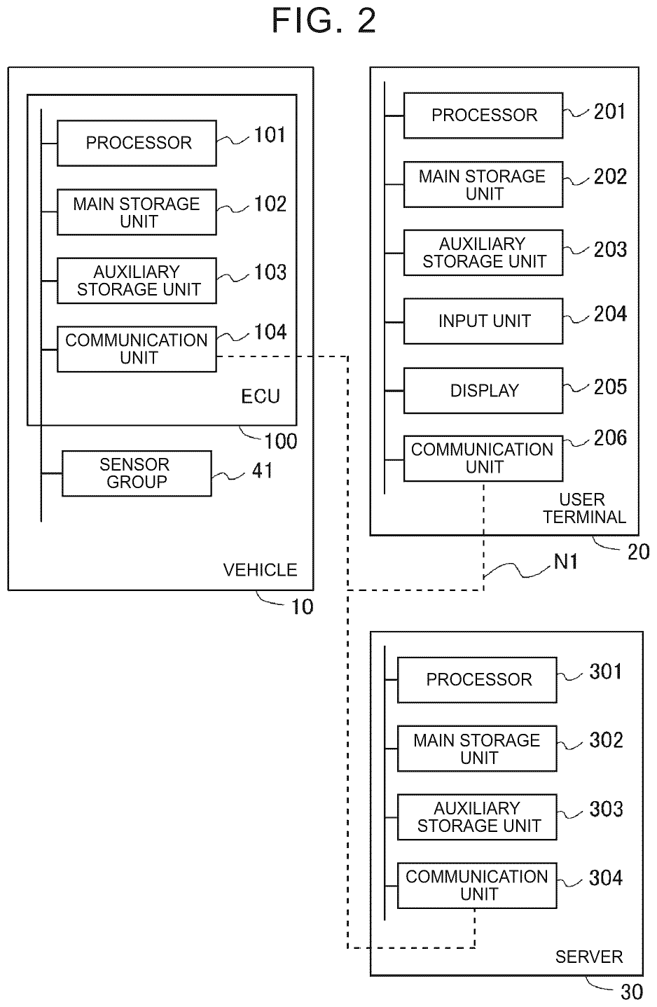

The hardware configurations of the vehicle 10, the user terminal 20, and the server 30 will be described with reference to FIG. 2. FIG. 2 is a block diagram schematically showing an example of the configurations of the vehicle 10, the user terminal 20, and the server 30 constituting the system 1 according to the first embodiment.

The server 30 has a computer configuration. The server 30 includes a processor 301, a main storage unit 302, an auxiliary storage unit 303, and a communication unit 304. These components are connected to each other by a bus. The processor 301 is an example of a control unit.

The processor 301 is a central processing unit (CPU), a digital signal processor (DSP), or the like. The processor 301 controls the server 30 and performs various information processing calculations. The main storage unit 302 is a random access memory (RAM), a read-only memory (ROM), or the like. The auxiliary storage unit 303 is an erasable programmable ROM (EPROM), a hard disk drive (HDD), a removable medium, or the like. The auxiliary storage unit 303 stores an operating system (OS), various programs, various tables, and the like. The processor 301 loads the program stored in the auxiliary storage unit 303 into a work area of the main storage unit 302 and executes the program. Through the execution of the program, each component is controlled. As a result, the server 30 implements functions that meet predetermined purposes. The main storage unit 302 and the auxiliary storage unit 303 are computer-readable recording media. The server 30 may be a single computer or may include a plurality of computers linked together. The information stored in the auxiliary storage unit 303 may be stored in the main storage unit 302. The information stored in the main storage unit 302 may be stored in the auxiliary storage unit 303.

The communication unit 304 is means for communicating with the vehicle 10 and the user terminal 20 via the network N1. The communication unit 304 is, for example, a local area network (LAN) interface board or a wireless communication circuit for wireless communication. The LAN interface board and the wireless communication circuit are connected to the network N1.

The series of processes executed by the server 30 can be executed by hardware or software.

Next, the user terminal 20 will be described. The user terminal 20 is a small computer such as a smartphone, a mobile phone, a tablet terminal, a personal information terminal, a wearable computer (smart watch etc.), or a personal computer (PC). The user terminal 20 includes a processor 201, a main storage unit 202, an auxiliary storage unit 203, an input unit 204, a display 205, and a communication unit 206. These components are connected to each other by a bus. The processor 201, the main storage unit 202, and the auxiliary storage unit 203 are similar to the processor 301, the main storage unit 302, and the auxiliary storage unit 303 of the server 30, respectively, and therefore description thereof will be omitted.

The input unit 204 is means for receiving an input operation performed by the user. Examples of the input unit 204 include a touch panel, a mouse, a keyboard, a microphone, and a push button. The display 205 is means for presenting information to the user. Examples of the display 205 include a liquid crystal display (LCD) and an electroluminescence (EL) panel. The input unit 204 and the display 205 may be configured as one touch panel display.

The communication unit 206 is communication means for connecting the user terminal 20 to the network N1. The communication unit 206 is a circuit for communicating with other devices (for example, the vehicle 10 or the server 30) via the network N1 by using a wireless communication network such as a mobile communication service (for example, a telephone communication network such as the sixth generation (6G), the fifth generation (5G), the fourth generation (4G), the third generation (3G), and long term evolution (LTE)), Wi-Fi (registered trademark), or Bluetooth (registered trademark).

Next, the vehicle 10 will be described. The vehicle 10 includes an ECU 100 as an electronic control unit and a sensor group 41. These components are connected to each other by a controller area network (CAN) bus that is a bus of an in-vehicle network. Each of these components may be implemented by a combination of in-vehicle devices such as a car navigation system or in-vehicle communication devices instead of a single module.

The ECU 100 has a computer configuration. The ECU 100 includes a processor 101, a main storage unit 102, an auxiliary storage unit 103, and a communication unit 104. These components are connected to each other by a bus. The processor 101, the main storage unit 102, the auxiliary storage unit 103, and the communication unit 104 are similar to the processor 201, the main storage unit 202, the auxiliary storage unit 203, and the communication unit 206 of the user terminal 20, respectively, and therefore description thereof will be omitted.

The sensor group 41 includes, for example, sensors that detect the state of the vehicle 10 and sensors that detect actions of a driver. The sensor group 41 includes, for example, a speed sensor, an acceleration sensor, an accelerator operation amount sensor, a steering angle sensor, a yaw rate sensor, a turn signal switch sensor (sensor that detects the switch state of a turn signal), a shift position sensor, a position information sensor (global positioning system (GPS) sensor), or a brake switch. The sensor group 41 may also include a sensor that detects activation of a pre-crash safety system or the like.

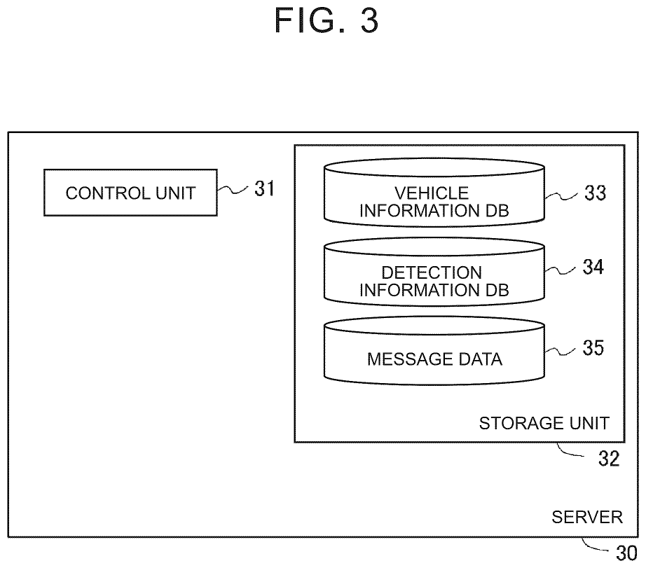

Next, functions of the server 30 will be described. FIG. 3 is a diagram showing an example of a functional configuration of the server 30 according to the first embodiment. The server 30 includes a control unit 31 and a storage unit 32 as functional components. The processor 301 of the server 30 executes the process of the control unit 31 by using a computer program stored in the main storage unit 302. The storage unit 32 includes the main storage unit 302 and the auxiliary storage unit 303. The storage unit 32 stores a vehicle information DB 33, a detection information DB 34, and message data 35. The vehicle information DB 33 and the detection information DB 34 are, for example, relational databases.

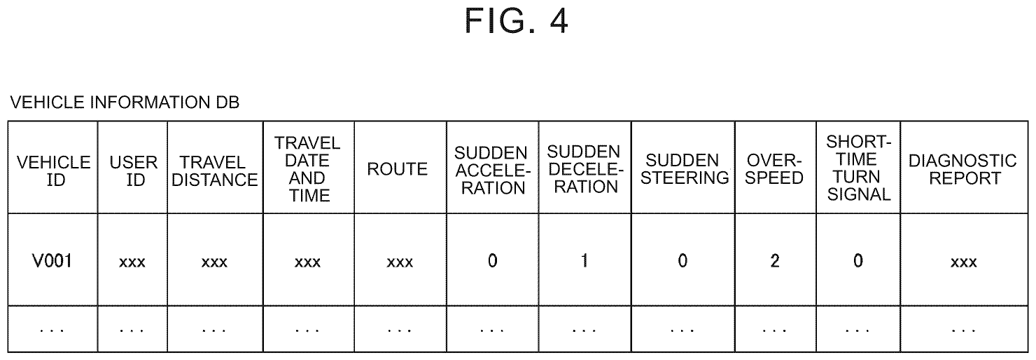

When travel information is received from the vehicle 10, the control unit 31 updates the vehicle information DB 33 and the detection information DB 34. The travel information is related to traveling of the vehicle 10, and includes detection values of the sensor group 41, a travel distance of the vehicle 10, travel date and time of the vehicle 10, a route of the vehicle 10, and a vehicle identifier (ID). FIG. 4 is a diagram showing an example of a table configuration of the vehicle information DB 33 according to the first embodiment. The vehicle information DB 33 has fields for vehicle ID, user ID, travel distance, travel date and time, route, sudden acceleration, sudden deceleration, sudden steering, overspeed, short-time turn signal, and diagnostic report. Each record of the vehicle information DB 33 is generated for each trip. For example, the travel information may be transmitted from the vehicle 10 to the server 30 for each trip, or may be transmitted from the vehicle 10 to the server 30 at predetermined time intervals.

Information for identifying the vehicle 10 (vehicle ID) is stored in the vehicle ID field. Information for identifying a user linked to the vehicle 10 (user ID) is stored in the user ID field. The vehicle 10 and the user terminal 20 are linked to the user ID. Information on the total travel distance of the vehicle 10 at the start of a trip is stored in the travel distance field. Information on a date and time when the vehicle 10 traveled is stored in the travel date and time field. The date and time when the vehicle 10 traveled may include information on a date and time when the vehicle 10 was activated, a date and time when the vehicle 10 was shut down, or both of them. Information on a count of sudden acceleration of the vehicle 10 is stored in the sudden acceleration field. For example, sudden acceleration means that the speed of the vehicle 10 has increased by 6 km/h or more in 0.5 seconds. Therefore, the control unit 31 can detect sudden acceleration based on the speed of the vehicle 10. When sudden acceleration is detected, the control unit 31 adds 1 to the value of the sudden acceleration field.

Information on a count of sudden deceleration of the vehicle 10 is stored in the sudden deceleration field. For example, sudden deceleration means that the speed of the vehicle 10 has decreased by 7 km/h or more in 0.5 seconds. Therefore, the control unit 31 can detect sudden deceleration based on the speed of the vehicle 10. When sudden deceleration is detected, the control unit 31 adds 1 to the value of the sudden deceleration field.

Information on a count of sudden steering of the vehicle 10 is stored in the sudden steering field. For example, sudden steering means that the angular acceleration of the steering angle has reached a threshold value or more. Therefore, the control unit 31 can determine whether sudden steering has occurred based on the steering angle of the vehicle 10. When sudden steering is detected, the control unit 31 adds 1 to the value of the sudden steering field.

Information on a count of overspeed of the vehicle 10 is stored in the overspeed field. For example, the control unit 31 determines that overspeed has occurred when the speed of the vehicle 10 is 120 km/h or more. When overspeed is detected, the control unit 31 adds 1 to the value of the overspeed field.

Information on a count of short-time turn signal is stored in the short-time turn signal field. Short-time turn signal means that the blinking period of the turn signal is shorter than an appropriate period. For example, the control unit 31 determines that short-time turn signal has occurred when the turn signal switch is ON for 2.0 seconds or less. When the short-time turn signal is detected, the control unit 31 adds 1 to the value of the short-time turn signal field. Information on a diagnostic report is input to the diagnostic report field. For example, information on a storage location of the diagnostic report is input. The diagnostic report is generated by the control unit 31. The generation of the diagnostic report will be described later.

The information stored in the vehicle information DB 33 is not limited to the above information as long as the information is necessary for driving diagnosis. For example, when the vehicle 10 travels at a speed higher than a speed limit set for a road by a predetermined value or more, when the vehicle 10 does not stop for a predetermined period or longer before being reversed, when automatic braking is activated by pre-crash safety, and when the vehicle 10 is reversed at a speed equal to or higher than a predetermined speed, these items may be stored in the vehicle information DB 33 as items to be used for driving diagnosis. Alternatively, only a part of the above information may be used.

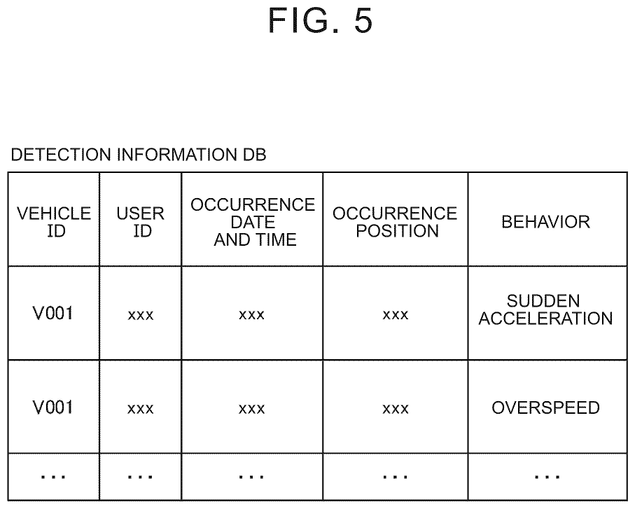

The control unit 31 updates the detection information DB 34 when a predetermined behavior is detected. FIG. 5 is a diagram showing an example of a table configuration of the detection information DB 34 according to the first embodiment. The detection information DB 34 has fields for vehicle ID, user ID, occurrence date and time, occurrence position, and behavior. Each record of the detection information DB 34 is generated every time the predetermined behavior is detected. The vehicle ID field and the user ID field are associated with the vehicle information DB 33. Information on a date and time when the predetermined behavior occurred is input to the occurrence date and time field. Information on a position where the predetermined behavior occurred is input to the occurrence position field. This position is a position on a route stored in the vehicle information DB 33. Information on a detected behavior is input to the behavior field. Any one of sudden acceleration, sudden deceleration, sudden steering, overspeed, and short-time turn signal as described in the vehicle information DB 33 is input to the behavior field.

The control unit 31 generates a diagnostic report for each trip. For example, the diagnostic report presents the occurrence of the predetermined behavior and advice or a message about driving to the user. The diagnostic report is stored in the auxiliary storage unit 303, and the user can view the diagnostic report by access from the user terminal 20.

The diagnostic report is generated to show that the predetermined behavior has occurred. When the control unit 31 generates the diagnostic report on a trip in which the predetermined behavior has occurred, the control unit 31 notifies the user terminal 20 about the generation of the diagnostic report. On a trip in which the predetermined behavior has not occurred, the user terminal 20 is not notified even if the diagnostic report is created.

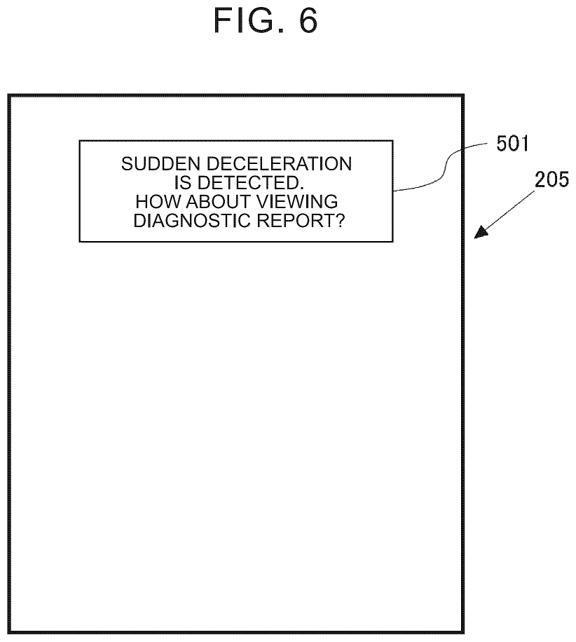

FIG. 6 is a diagram showing an example of an image displayed on the user terminal 20 when the user terminal 20 is notified that the diagnostic report is created. The control unit 31 displays a message 501 on the display 205 of the user terminal 20 by using, for example, push notification or e-mail. The message 501 may be a notification that the diagnostic report is created, a notification that prompts the user to view the diagnostic report, or a notification that the predetermined behavior is detected. The message 501 may be a message associated with the detected predetermined behavior.

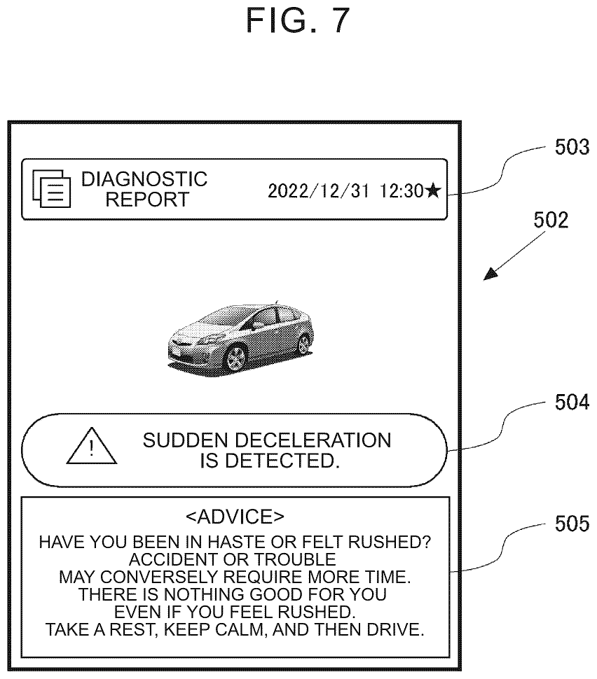

When the diagnostic report is created for the trip in which the predetermined behavior has occurred, the control unit 31 displays information indicating that the predetermined behavior is detected on an initial screen at the time of activation of an application for reference to the diagnostic report on the user terminal 20. FIG. 7 is a diagram showing an example of an initial screen 502 when the application is activated in response to detection of the predetermined behavior. The initial screen 502 is displayed first when the application is activated on the user terminal 20. This initial screen 502 may be displayed by tapping the notification shown in FIG. 6. As represented by reference symbol 503, the initial screen 502 displays information on the trip for which the diagnostic report is created. For example, “Diagnostic report 2022/12/31 12:30” indicates that the diagnosis report was created for a trip that started at 12:30 on Dec. 31, 2022. An asterisk is added to the right of the time in the diagnostic report for the trip in which the predetermined behavior is detected. By displaying the asterisk, the user can determine that the report is the diagnostic report for the trip in which the predetermined behavior is detected. The portion represented by reference symbol 503 functions as a push button for transition to a page of the corresponding diagnostic report when tapped by the user.

As represented by reference symbol 504, the initial screen 502 may display a message for notifying the user that the predetermined behavior is detected. For example, the user can be notified that sudden deceleration is detected by displaying a message “Sudden deceleration is detected.” The portion represented by reference symbol 504 may also function as a push button for transition to the page of the corresponding diagnostic report when tapped by the user. When the predetermined behavior is not detected in the previous trip, a message may be displayed to praise the user for safe driving. For example, a message “Thank you for driving safely today!” may be displayed.

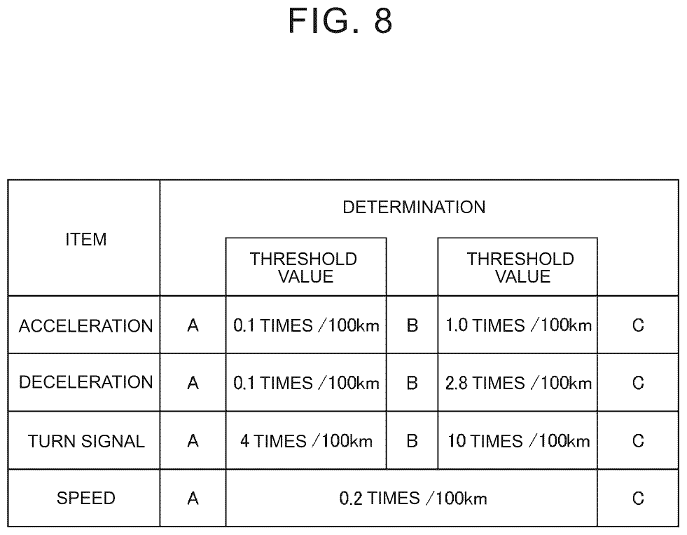

When a plurality of predetermined behaviors is detected in one trip, a message associated with an “item with highest care” is displayed at the position represented by reference symbol 504. The item with highest care is determined as follows. FIG. 8 is a diagram showing a relationship between scores and threshold values associated with predetermined behaviors. The score is calculated for each item. In each item, “A” is a score when the number of occurrences is small, “C” is a score when the number of occurrences is large, and “B” is an intermediate score. The speed is represented by the scores “A” and “C” without the score “B”. The score is obtained by conversion to the number of detections of the predetermined behavior when the vehicle 10 travels 100 km. For example, in an “acceleration” item, sudden acceleration is detected when the speed of the vehicle 10 has increased by 6 km/h or more in 0.5 seconds as described above. For example, the score is “A” when the number of detections of sudden acceleration per 100 km travel of the vehicle 10 is less than 0.1, the score is “B” when the number of detections is 0.1 or more and less than 1.0, and the score is “C” when the number of detections is 1.0 or more. The score “C” indicates a relatively high correlation with the occurrence of an accident. Therefore, it is preferable that the scores be “A” or “B” for all the items.

Assuming that the number of occurrences of each item (that is, the predetermined behavior) is X (times/100 km) and a threshold value at which the score is “C” is Y (times/100 km), the control unit 31 displays an item with the largest value (X/Y) obtained by dividing X by Y at the position represented by reference symbol 504 as the “item with highest care”. As an alternative method, when the automatic braking is activated by pre-crash safety, the activation may be displayed as the item with highest care. As a still alternative method, when a plurality of predetermined behaviors is detected, an item selected at random from among these items may be displayed as the item with highest care.

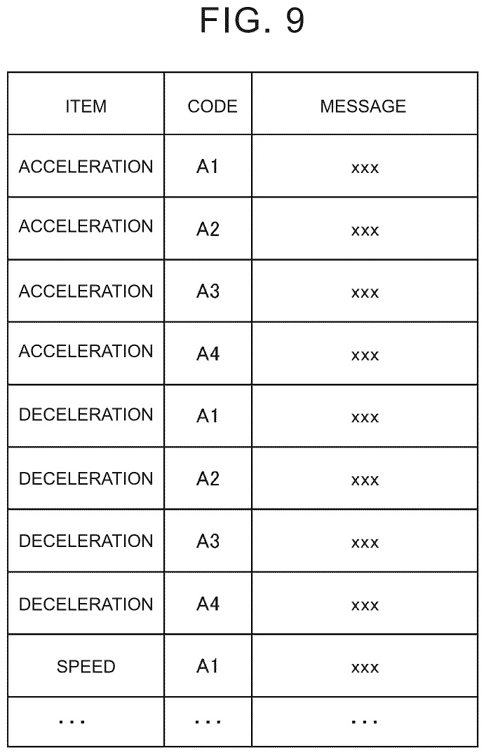

Returning to FIG. 7, as represented by reference symbol 505, the initial screen 502 displays a message for the item with highest care. This message is stored in the message data 35. FIG. 9 is a diagram showing data on messages associated with items stored in the message data 35. A plurality of messages is provided for the items. In the example shown in FIG. 9, four messages with codes A1 to A4 are stored for each item. The control unit 31 selects one message associated with the item with highest care, and displays it at the position represented by reference symbol 505. The control unit 31 may select a message at random, may select a message based on a date as described later, or may select a message different from the previous message or a message on the previous day. By preventing continuous display of similar messages, it is possible to reduce the occurrence of a case where the user is bored.

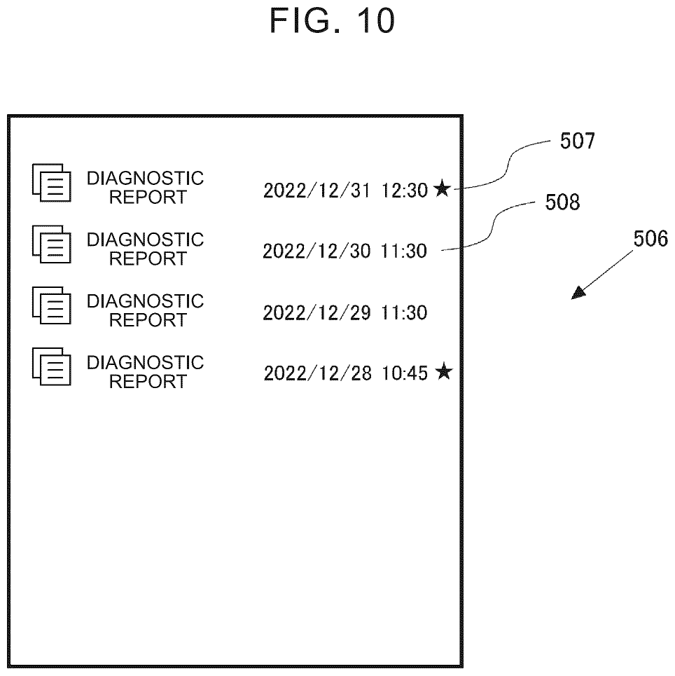

The control unit 31 can cause the user terminal 20 to display a list of diagnostic reports. FIG. 10 is a diagram showing an example of a screen 506 when the list of diagnostic reports is displayed. The list of diagnostic reports is generated by the control unit 31. When the user taps a push button for displaying the list of diagnostic reports on the user terminal 20, a request for displaying the list of diagnostic reports is transmitted from the user terminal 20 to the server 30. In response to this request, the control unit 31 transmits information for displaying the image shown in FIG. 10 to the user terminal 20. In the example shown in FIG. 10, a plurality of diagnostic reports is displayed in chronological order. A diagnostic report in which the predetermined behavior is detected is marked with an asterisk at the right end. For example, a diagnostic report represented by reference symbol 507 is marked with the asterisk. Therefore, it can be understood that the diagnostic report is generated when the predetermined behavior is detected. A diagnostic report represented by reference symbol 508 is not marked with the asterisk. Therefore, it can be understood that the diagnostic report is generated when the predetermined behavior is not detected. By changing the display format between the diagnostic report when the predetermined behavior is detected and the diagnostic report when the predetermined behavior is not detected, the user can discriminate the diagnostic report when the predetermined behavior is detected.

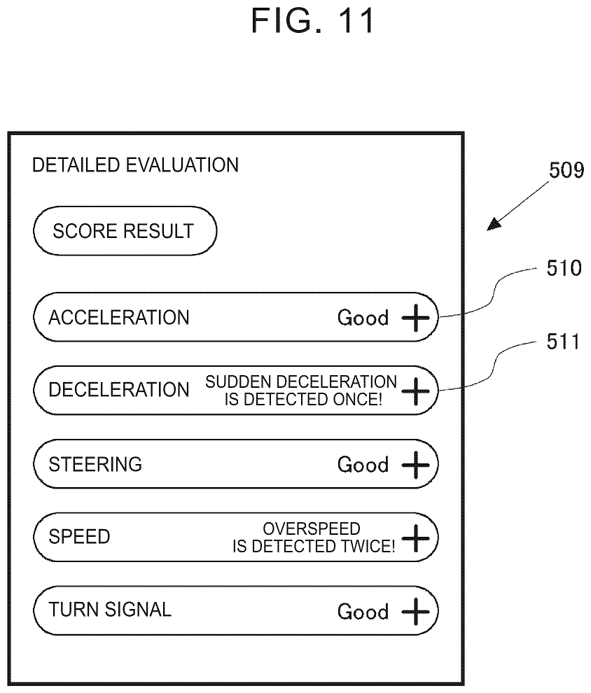

FIG. 11 is a diagram showing an example of a screen 509 when the diagnostic report is opened. For example, the screen 509 is opened by tapping the push button represented by reference symbol 503 on the initial screen 502. The example shown in FIG. 11 shows a diagnostic report when sudden deceleration (sudden braking) is detected once and overspeed is detected twice. As represented by reference symbol 510, for example, an image of “Good” is added to an undetected behavior. As represented by reference symbol 511, for example, an image of “Sudden deceleration is detected once!” is added to a detected behavior. Thus, the user can understand at a glance the number of times a specific behavior is detected.

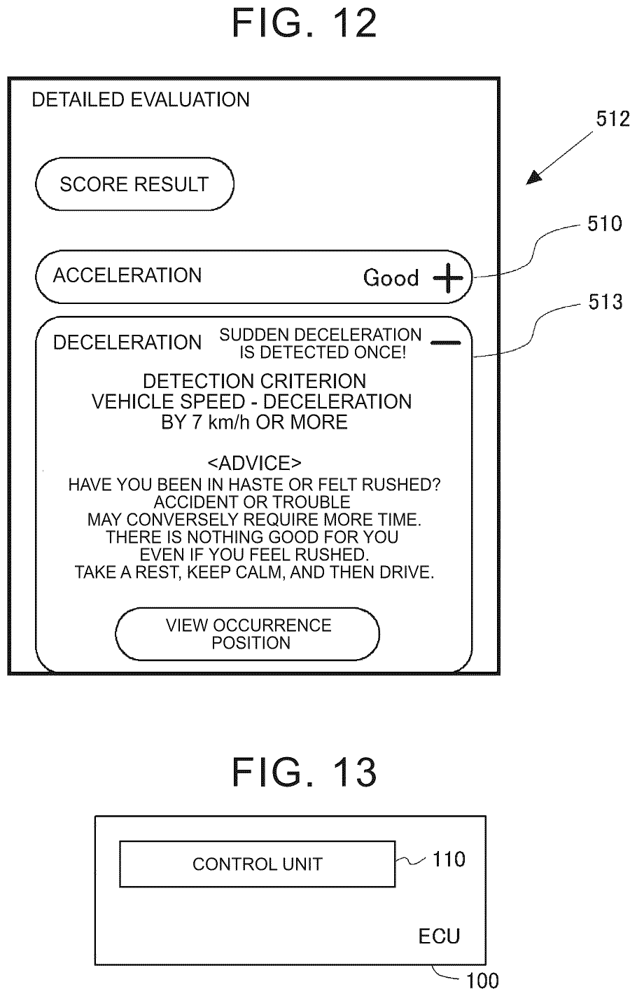

By tapping a “+” push button displayed at the right end of each item, contents associated with each item can be displayed. FIG. 12 is a diagram showing an example of a screen 512 displayed when a deceleration item is tapped. At this time, the control unit 31 displays advice together with a detection criterion. The detection criterion is a specific criterion for determining that the predetermined behavior has occurred. The advice to be displayed is selected by the control unit 31 from the message data 35 shown in FIG. 9. The control unit 31 displays, for example, a message different from a message displayed last time or a message displayed on the previous day so that the same message is not displayed continuously.

In order to select the message to be displayed, for example, the control unit 31 extracts a date from the travel date and time, and obtains the remainder of division of the date by 4. Referring to the message data 35 shown in FIG. 9, the control unit 31 selects a message with code A1 when the remainder is 1, selects a message with code A2 when the remainder is 2, selects a message with code A3 when the remainder is 3, and selects a message with code A4 when the remainder is 0. Since different messages can be displayed depending on the date, it is possible to reduce the occurrence of the case where the user is bored.

When the user taps a push button labeled “View occurrence position” on the screen 512, a map is displayed and the position where the behavior is detected is shown on the map. The control unit 31 displays the route and the occurrence position on the map based on the information on the route stored in the vehicle information DB 33 and the information on the occurrence position stored in the detection information DB 34.

Next, a functional component of the ECU 100 of the vehicle 10 will be described. FIG. 13 is a diagram showing an example of the functional component of the ECU 100 according to the first embodiment. The ECU 100 includes a control unit 110 as the functional component. The processor 101 of the ECU 100 executes the process of the control unit 110 by using a computer program stored in the main storage unit 102. Any of the functional components or a part of the processes thereof may be executed by a hardware circuit.

The control unit 110 transmits information on detection values of the sensor group 41 to the server 30 at predetermined time intervals or in every trip. At this time, this information is transmitted as travel information together with information necessary for driving diagnosis such as the vehicle ID, position information, and time information.

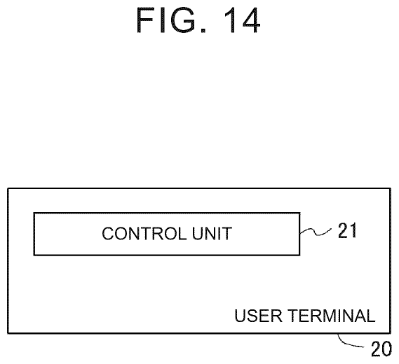

Next, the function of the user terminal 20 will be described. FIG. 14 is a diagram showing a functional configuration of the user terminal 20 according to the first embodiment. The user terminal 20 includes a control unit 21 as a functional component. The processor 201 of the user terminal 20 executes the process of the control unit 21 by using a computer program stored in the main storage unit 202. A part of the processes of the control unit 21 may be executed by a hardware circuit. The application for reference to the diagnostic report is installed in the user terminal 20.

The control unit 21 receives, from the server 30, a notification that the diagnostic report is created. This notification is, for example, push notification, short message service (SMS) notification, or e-mail notification. This notification may include a command to display, on the display 205, information indicating that the diagnostic report is created. For example, when the push notification is received, the control unit 21 causes the display 205 to display an image shown in FIG. 6.

When the user taps the message portion represented by reference symbol 501 in FIG. 6, the control unit 21 activates the application for reference to the diagnostic report. When the application is activated by the control unit 21, the initial screen 502 shown in FIG. 7 is displayed. At this time, the control unit 21 accesses the server 30 and requests information necessary for displaying the initial screen 502.

When the user taps the position represented by reference symbol 503 on the initial screen 502, the control unit 21 displays the screen 509 shown in FIG. 11. At this time, the control unit 21 accesses the server 30 and requests information necessary for displaying the screen 509. When the user taps the “+” push button of each item in the diagnostic report, the control unit 21 displays the contents associated with each item. Information necessary for display at this time is also requested from the server 30.

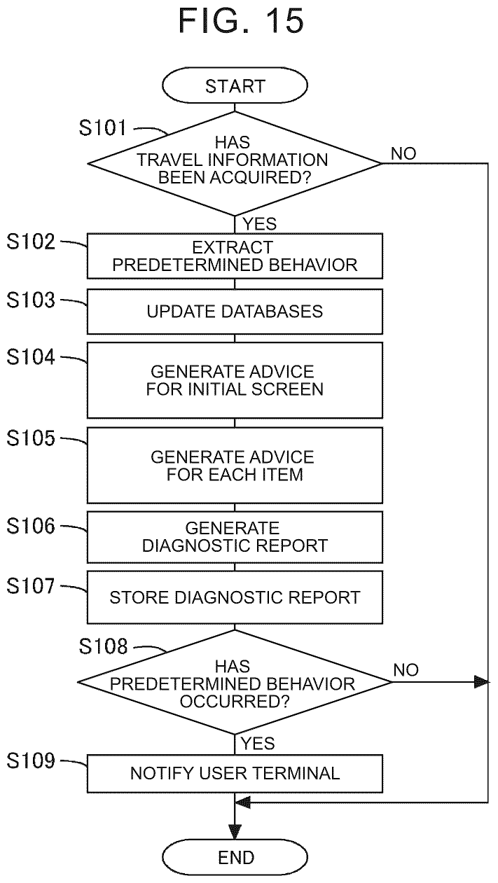

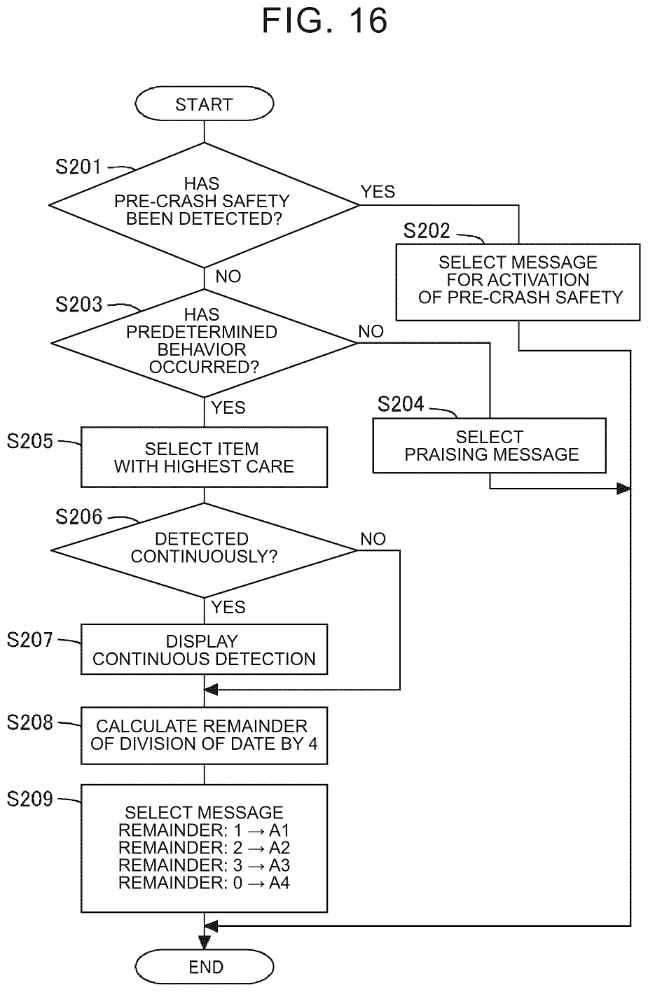

Next, a diagnostic report notification process in the server 30 will be described. FIG. 15 is a flowchart of the diagnostic report notification process in the server 30 according to the first embodiment. The process shown in FIG. 15 is executed in the server 30 for each trip of the vehicle 10.

In step S101, the control unit 31 determines whether travel information has been received from the vehicle 10. For example, the travel information may be transmitted from the vehicle 10 when the vehicle 10 is shut down (may be transmitted when ignition is OFF (IG-OFF)), or may be transmitted from the vehicle 10 at predetermined time intervals. When the determination result is “Yes” in step S101, the process proceeds to step S102. When the determination result is “No”, the process is terminated.

In step S102, the control unit 31 extracts the predetermined behavior. Based on the detection values of the sensor group 41, the control unit 31 determines whether the predetermined behavior has occurred. In step S103, the control unit 31 updates the vehicle information DB 33 and the detection information DB 34 based on the predetermined behavior. That is, when the predetermined behavior has occurred, 1 is added to the corresponding record in the vehicle information DB 33 and a new record is generated in the detection information DB 34.

In step S104, the control unit 31 generates advice to be displayed on the initial screen 502. FIG. 16 is a flowchart of a process for generating the advice to be displayed on the initial screen 502. The process shown in FIG. 16 is executed in step S104. In step S201, the control unit 31 determines whether activation of the pre-crash safety has been detected. Whether the activation of the pre-crash safety has been detected is determined based on the detection values of the sensor group 41. When the activation of the pre-crash safety has been detected, this fact is displayed on the initial screen 502 with priority. Therefore, when the determination result is “Yes” in step S201, the process proceeds to step S202, and the control unit 31 selects a message associated with the activation of the pre-crash safety. This message is stored in the auxiliary storage unit 303. A plurality of messages may be stored in the auxiliary storage unit 303 in association with the activation of the pre-crash safety. For example, the control unit 31 may select the message so that the same message is not displayed continuously.

When the determination result is “No” in step S201, the process proceeds to step S203. In step S203, the control unit 31 determines whether the predetermined behavior has occurred. When the predetermined behavior has not occurred, the initial screen 502 displays a message for praising the user's driving. Therefore, when the determination result is “No” in step S203, the process proceeds to step S204, and the control unit 31 selects the message for praising the user's driving. This message is also stored in the auxiliary storage unit 303. A plurality of messages for praising the user's driving may be stored and, for example, the control unit 31 may select the message so that the same message is not displayed continuously.

When the determination result is “Yes” in step S203, the process proceeds to step S205, and the control unit 31 selects an item with highest care. The control unit 31 selects the item with highest care as described with reference to FIG. 8. In step S206, the control unit 31 determines whether the selected item is detected continuously. When the selected item is detected continuously, for example, an additional message “Sudden acceleration has occurred twice in a row.” is displayed. Therefore, when the determination result is “Yes” in step S206, the process proceeds to step S207, and the control unit 31 contains the continuous detection in the advice. When the determination result is “No” in step S206, the process proceeds to step S208.

In step S208, the control unit 31 calculates the remainder of division of a trip date by 4. For example, in a trip on December 31, the remainder of division of 31 by 4 is 3. In step S209, the control unit 31 selects a message. The message is selected based on the remainder calculated in step S208. For example, the remainder is 3 in the trip on December 31. Therefore, the message with code A3 is selected. This message is associated with the item selected in step S205, and the control unit 31 selects it from the message data 35. In this way, the message to be displayed on the initial screen 502 is selected.

Returning to FIG. 15, the control unit 31 generates advice for each item in step S105. The advice for each item is selected as shown in FIG. 12. The advice is associated with the predetermined behavior extracted in step S102 and selected from the message data 35. For example, the advice may be selected in the same manner as in step S104. As an alternative method, the control unit 31 may select advice different from the previous one by selecting code A1 to code A4 sequentially.

In step S106, the control unit 31 generates a diagnostic report. The diagnostic report includes the advice for the item corresponding to the predetermined behavior. In step S107, the control unit 31 stores the diagnostic report in the auxiliary storage unit 303. In addition, the auxiliary storage unit 303 also stores the advice to be displayed on the initial screen 502.

In step S108, the control unit 31 determines whether the predetermined behavior has occurred. When the determination result is “Yes” in step S108, the process proceeds to step S109. In step S109, the control unit 31 notifies the user terminal 20 that the diagnostic report is created. When the determination result is “No” in step S108, the process is terminated without notifying the user terminal 20.

As described above, according to the present embodiment, the notification is transmitted to the user terminal 20 when the diagnostic report created in response to detection of the predetermined behavior is issued. Therefore, the user can view the diagnostic report with many interests in response to the notification. Thus, it is possible to reduce the occurrence of the case where the user is bored with the application.

### Second Embodiment

In the first embodiment, the diagnostic report is created for each trip. In a second embodiment, the diagnostic report is created only for a trip in which the predetermined behavior is detected. A notification is transmitted to the user terminal 20 every time the diagnostic report is created.

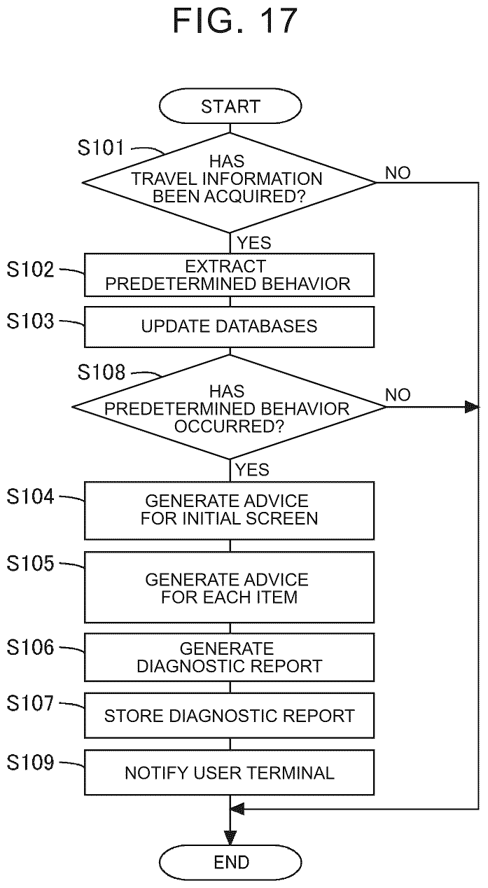

Next, a diagnostic report notification process in the server 30 will be described. FIG. 17 is a flowchart of the diagnostic report notification process in the server 30 according to the second embodiment. The process shown in FIG. 17 is executed in the server 30 for each trip of the vehicle 10. The process shown in FIG. 17 is different from the process shown in FIG. 15 only in term of the order of the process in step S108. Therefore, description thereof will be omitted.

In this way, the diagnostic report is created only for the trip in which the predetermined behavior is detected. Thus, the diagnostic report with interests for the user is created. Thus, it is possible to reduce the occurrence of the case where the user is bored with the application.

### Third Embodiment

A third embodiment differs from the first embodiment in terms of the method for selecting the message to be displayed on the initial screen 502 and the diagnostic report. In the third embodiment, a message preferred by the user is presented with priority, thereby reducing the occurrence of the case where the user is bored with the application. For example, a message with the same tendency as that of the message frequently referred to by the user is displayed with priority. For example, messages including the following contents are conceivable as the message with the same tendency. That is, the messages are a message describing an accident that will occur due to the predetermined behavior, a message describing the way of reducing the predetermined behavior, a message describing the degree of increase in the accident rate due to the predetermined behavior, and a message describing a relationship between the predetermined behavior and fuel efficiency.

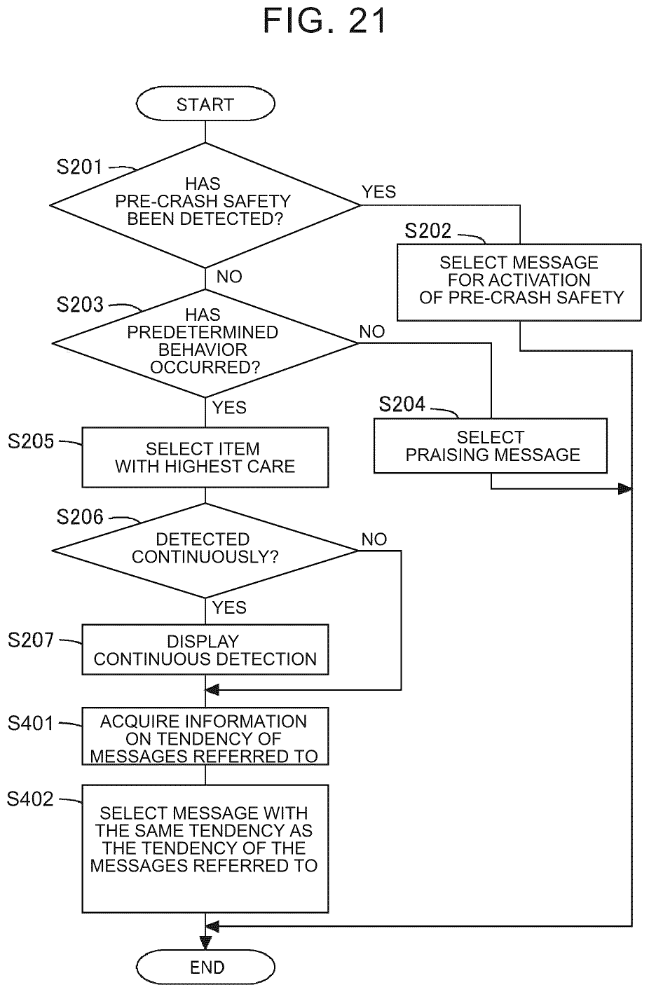

For example, the control unit 31 may determine that the user is reading the message for a longer period as the initial screen 502 is displayed for a longer period, and may determine that the message is preferred by the user. For example, the control unit 31 may determine that the message displayed on the initial screen 502 is preferred by the user as the frequency of transition from the initial screen 502 to the diagnostic report increases. Therefore, the control unit 31 acquires, from the user terminal 20, information on the display period of the initial screen 502 or information on the transition from the initial screen 502 to the diagnostic report, and determines the message preferred by the user. In other words, as shown in FIG. 21, the control unit acquires information on a tendency of messages referred to by the user in step S401, and selects a message with the same tendency as the tendency of the messages referred to by the user in step S402.

For example, messages with the same tendency for any items are stored with code A1 in the message data 35. Similarly, messages with the same tendency among the items are stored with codes A2, A3, and A4. For example, when there is a high probability that the user views the message with code A1, the message with code A1 is selected with priority. For example, the message may be selected so that the selection probability increases as the message is referred to by the user more frequently. For example, the message preferred by the user may be displayed every predetermined number of times.

By displaying the message preferred by the user with priority, it is possible to reduce the occurrence of the case where the user is bored with the application. In addition, it is possible to increase the frequency of use of the application.

### Fourth Embodiment

In a fourth embodiment, an incentive is given to the user based on a result of driving diagnosis. For example, a predetermined amount of money may be deposited or points may be added on the application for a trip in which the predetermined behavior is not detected. The points may be used, for example, to pay for automobile insurance, purchase a vehicle, or pay for toll roads. For example, in automobile leasing, a leasing company pays an automobile insurance fee. Therefore, the insurance fee paid by the leasing company increases when an accident occurs. When the incentive is given to the user based on the result of driving diagnosis, the user tries to drive safely. Therefore, accidents can be reduced. When the incentives are given only to users of the application, the number of users of the application can be increased. Therefore, it is possible to present driving advice to the users, thereby reducing accidents.

There is a case where the resources for giving incentives are limited. In the fourth embodiment, a cap (an upper limit) is set for the incentive, and the incentive is effectively given within the resources. For example, the cap may be provided for each trip, each day, each week, each month, or each year.

For example, it is assumed that the upper limit of a yearly incentive per person is set to 5000 points, the upper limit of a monthly incentive is set to 200 points (2400 points yearly), and a campaign incentive is set to 800 points. In this case, 1800 points remain based on calculation of “5000−2400 −800”. Therefore, an incentive per day is given from the 1800 points. When the total value of the incentives given per day reaches 1800 points, the giving of incentives is terminated.

The 1800 points may be considered in terms of a year. That is, when the total of the incentives given per day in one year reaches 1800 points, no daily incentives may be given afterwards in that year. The points may be considered in terms of a month. For example, the upper limit of the incentive per month may be 150 points based on calculation of “1800/12”. That is, when the total of the incentives given per day in one month reaches 150 points, no daily incentives may be given afterwards in that month.

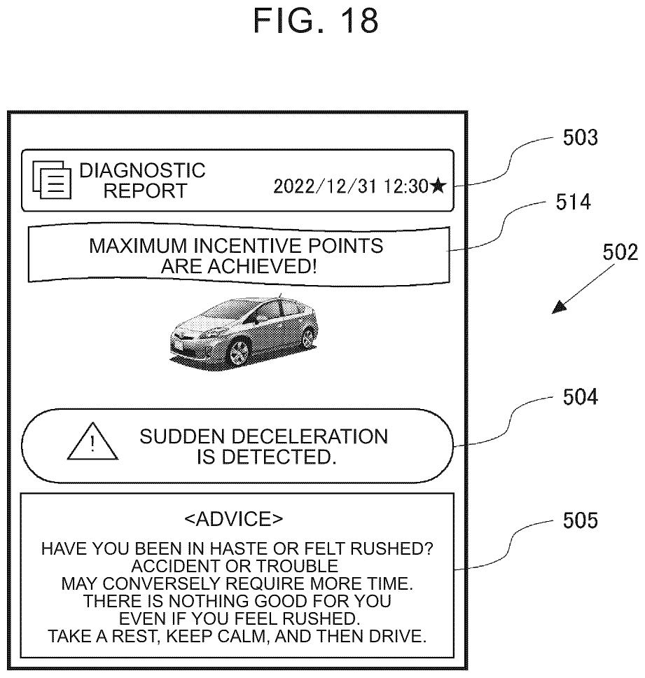

When the incentive reaches the upper limit, for example, a message “Maximum points are achieved!” may be displayed on the initial screen 502. Thus, the user can obtain a sense of achievement. FIG. 18 is a diagram showing an example of the initial screen 502 when the incentive has reached the upper limit. When the incentive has reached the upper limit, the control unit 31 causes the initial screen 502 to display a message indicating that the incentive has reached the upper limit as represented by reference symbol 514.

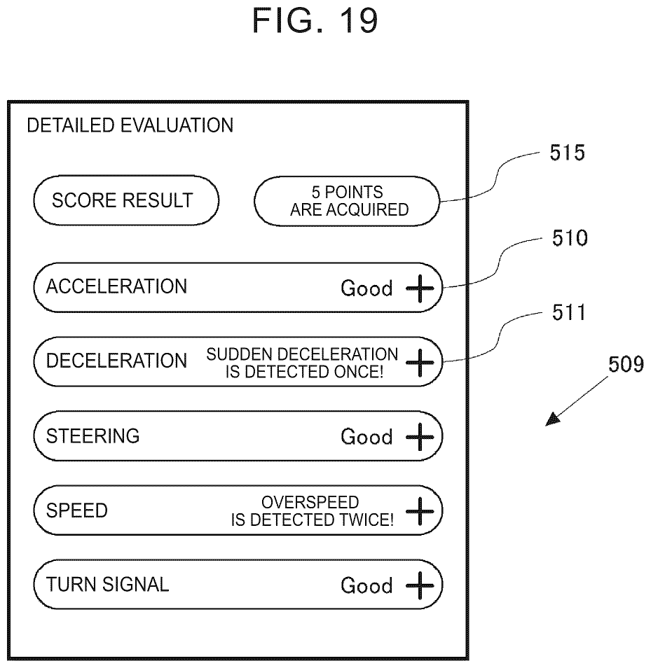

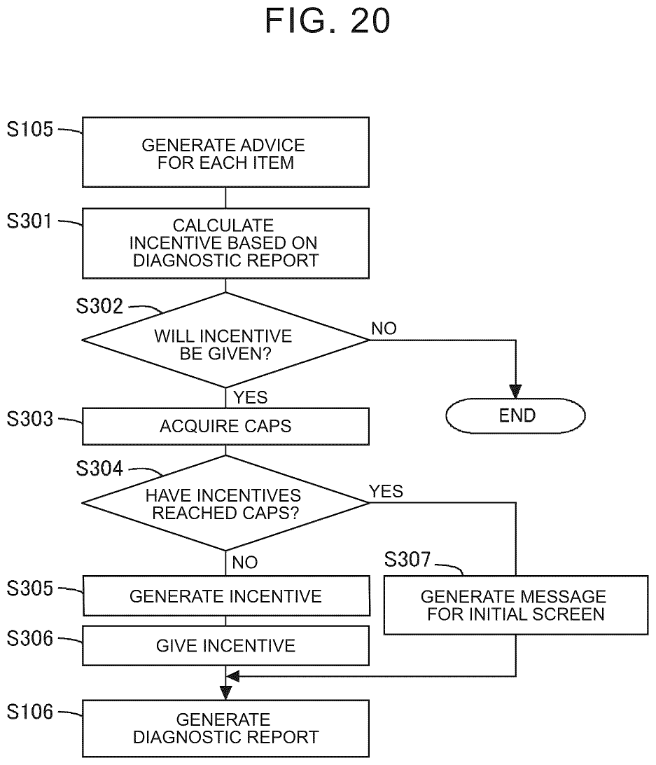

The incentive may be given for each trip based on the result of driving diagnosis, or a constant value may be given as in a case of a login bonus. For example, 3 points may be given for each item when the score shown in FIG. 8 is “A”, 2 points may be given for each item when the score is “B”, and 0 points may be given for each item when the score is “C”. For example, 2 points may be given uniformly as a login bonus. FIG. 19 is a diagram showing an example of a diagnostic report when the incentive is given. For example, when points are given based on driving diagnosis, the control unit 31 displays a message “5 points are acquired” in the diagnostic report as represented by reference symbol 515.

FIG. 20 is a flowchart of a process for giving the incentive in the server 30 according to the fourth embodiment. The process shown in FIG. 20 is executed in the middle of the flowchart shown in FIG. 15. The process before step S105 and the process after step S106 are the same as those in the flowchart shown in FIG. 15. Therefore, illustration and description will be omitted.

In the flowchart shown in FIG. 20, the process proceeds to step S301 when the process in step S105 is finished. In step S301, the control unit 31 calculates the incentive based on the diagnostic report. At this time, the incentive is calculated, for example, based on the score. As an alternative method, the incentive may be a fixed value. In step S302, the control unit 31 determines whether to give the incentive. For example, when the incentive calculated in step S301 is 0, the control unit 31 determines not to give the incentive. When the determination result is “Yes” in step S302, the process proceeds to step S303. When the determination result is “No”, the process is terminated.

In step S303, the control unit 31 acquires caps set for the incentive. For example, a daily cap, a weekly cap, a monthly cap, and a yearly cap are provided, and these caps are stored in the auxiliary storage unit 303. In step S304, the control unit 31 determines whether the incentives given thus far have reached the caps. For example, the daily cap, the weekly cap, the monthly cap, and the yearly cap are compared with the incentives given thus far to determine whether the incentives have reached the caps. For example, the incentives given thus far are stored in the auxiliary storage unit 303 together with date information. When the determination result is “Yes” in step S304, the process proceeds to step S307. When the determination result is “No”, the process proceeds to step S305.

In step S305, the control unit 31 generates the incentive. At this time, the incentive is generated so that the incentive determined in step S301 will be given to the user. In step S306, the control unit 31 gives the incentive to the user. For example, information on the incentive is transmitted to the user terminal 20 and stored in the auxiliary storage unit 203 of the user terminal 20. The control unit 31 generates a diagnostic report in step S106 to display, in the diagnostic report, a message indicating that the incentive has been given. At this time, the user terminal 20 displays the giving of the incentive as represented by reference symbol 515 in FIG. 19.

In step S307, the control unit 31 generates a message for the initial screen 502 to display, on the initial screen 502, information indicating that the incentives have reached the upper limit.

As described above, according to the present embodiment, the incentive is given to the user based on the result of driving diagnosis. Therefore, the user tries to drive safely, and accidents can be reduced. Since the incentive is given when the application is installed, the installation of the application can be promoted. As a result, the user has more opportunities to view the diagnostic report. Therefore, the number of occurrences of the predetermined behavior can be reduced. Thus, accidents can be reduced. Further, it is possible to reduce the occurrence of the case where the user is bored with the application.

### Other Embodiments

The embodiments described above are merely illustrative, and the present disclosure may be modified as appropriate without departing from the spirit and scope of the present disclosure. The processes and means described in the present disclosure can be combined as desired as long as no technical contradiction occurs. The process described as being executed by a single device may be executed by a plurality of devices in cooperation. Alternatively, the process described as being executed by different devices may be executed by a single device. In a computer system, the hardware configuration (server configuration) that implements functions can be changed flexibly. For example, the vehicle 10 may have a part or all of the functions of the server 30. For example, the vehicle 10 may have a part or all of the functions of the user terminal 20.

The present disclosure may be embodied such that a computer program that implements the functions described in the above embodiments is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any kind of disk or disc such as a magnetic disk (floppy (registered trademark) disk, hard disk drive (HDD), etc.) and an optical disc (compact disc (CD) ROM, digital versatile disc (DVD), Blu-ray disc, etc.), a read-only memory (ROM), a random access memory (RAM), an EPROM, an electrically erasable programmable ROM (EEPROM), a magnetic card, a flash memory, an optical card, and any kind of medium suitable for storing electronic instructions.

What is claimed is:

1. An information processing device comprising a control unit, wherein the control unit is configured to
acquire information on driving of a user,
determine, for each trip, whether a predetermined event has occurred based on the information on the driving of the user, and create a diagnostic report associated with the predetermined event, and
notify the user that the diagnostic report is present in response to creation of the diagnostic report associated with the predetermined event.

2. The information processing device according to claim 1, wherein the control unit is configured to
create the diagnostic report for the each trip based on the information on the driving of the user,
notify the user that the diagnostic report is present for a trip in which the predetermined event has occurred, and
not notify the user that the diagnostic report is present for a trip in which the predetermined event has not occurred.

3. The information processing device according to claim 1, wherein the control unit is configured to
create the diagnostic report for a trip in which the predetermined event has occurred, and
not create the diagnostic report for a trip in which the predetermined event has not occurred.

4. The information processing device according to claim 1, wherein the control unit is configured to
create the diagnostic report for the each trip based on the information on the driving of the user, and
notify the user that the diagnostic report associated with the predetermined event is present by changing, on a user interface for displaying a list of the diagnostic reports, a display format between a diagnostic report associated with a trip in which the predetermined event has occurred and a diagnostic report associated with a trip in which the predetermined event has not occurred.

5. The information processing device according to claim 1, wherein the control unit is configured to notify the user that the diagnostic report associated with the predetermined event is present by displaying information indicating that the diagnostic report associated with the predetermined event is present on an initial screen of a user interface for providing the diagnostic report in response to occurrence of the predetermined event.

6. The information processing device according to claim 1, further comprising a storage unit configured to store information on a plurality of messages associated with the predetermined event, wherein the control unit is configured to contain, in the diagnostic report, a message that satisfies a predetermined condition among the messages in response to occurrence of the predetermined event.

7. The information processing device according to claim 1, further comprising a storage unit configured to store information on a plurality of messages associated with the predetermined event, wherein the control unit is configured to display a message that satisfies a predetermined condition among the messages on an initial screen of a user interface for providing the diagnostic report in response to occurrence of the predetermined event.

8. The information processing device according to claim 6, wherein the control unit is configured to select a message different from a previous message or a message on a previous day as the message that satisfies the predetermined condition.

9. The information processing device according to claim 6, wherein the control unit is configured to
acquire information on a tendency of messages referred to by the user, and
select a message with the same tendency as the tendency of the messages referred to by the user as the message that satisfies the predetermined condition.

10. The information processing device according to claim 1, wherein the control unit is configured to
generate information on an incentive based on the information on the driving of the user, and
provide a cap for the incentive in every trip or every predetermined period.

11. The information processing device according to claim 10, wherein the control unit is configured to contain the information on the incentive in the diagnostic report.

12. An information processing method executed by a computer, comprising:
acquiring information on driving of a user;
determining, for each trip, whether a predetermined event has occurred based on the information on the driving of the user, and creating a diagnostic report associated with the predetermined event; and
notifying the user that the diagnostic report is present in response to creation of the diagnostic report associated with the predetermined event.

13. The information processing method according to claim 12, further comprising:
creating the diagnostic report for the each trip based on the information on the driving of the user;
notifying the user that the diagnostic report is present for a trip in which the predetermined event has occurred; and
not notifying the user that the diagnostic report is present for a trip in which the predetermined event has not occurred.

14. The information processing method according to claim 12, further comprising:
creating the diagnostic report for a trip in which the predetermined event has occurred; and
not creating the diagnostic report for a trip in which the predetermined event has not occurred.

15. The information processing method according to claim 12, further comprising:
creating the diagnostic report for the each trip based on the information on the driving of the user; and
notifying the user that the diagnostic report associated with the predetermined event is present by changing, on a user interface for displaying a list of the diagnostic reports, a display format between a diagnostic report associated with a trip in which the predetermined event has occurred and a diagnostic report associated with a trip in which the predetermined event has not occurred.

16. The information processing method according to claim 12, further comprising notifying the user that the diagnostic report associated with the predetermined event is present by displaying information indicating that the diagnostic report associated with the predetermined event is present on an initial screen of a user interface for providing the diagnostic report in response to occurrence of the predetermined event.

17. The information processing method according to claim 12, further comprising containing, in the diagnostic report, a message that satisfies a predetermined condition among a plurality of messages associated with the predetermined event in response to occurrence of the predetermined event.

18. The information processing method according to claim 12, further comprising displaying a message that satisfies a predetermined condition among a plurality of messages associated with the predetermined event on an initial screen of a user interface for providing the diagnostic report in response to occurrence of the predetermined event.

19. The information processing method according to claim 17, further comprising selecting a message different from a previous message or a message on a previous day as the message that satisfies the predetermined condition.

20. The information processing method according to claim 12, further comprising:
generating information on an incentive based on the information on the driving of the user; and
providing a cap for the incentive in every trip or every predetermined period.
